(19) United States
(12) Patent Application Publication
(10) Pub. No.: US 2007/0132824 A1
(43) Pub. Date: Jun. 14, 2007

(54) Image recording apparatus

(76) Inventors: Takayuki Iida, Kanagawa (JP); Eiichi Kito, Kanagawa (JP); Tsuyoshi Tanabe, Kanagawa (JP); Hajime Shirasaka, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 11/606,113

(22) Filed: Nov. 30, 2006

(30) Foreign Application Priority Data
Nov. 30, 2005 (JP) 2005-346491

(51) Int. Cl. B41J 2/01

(52) U.S. Cl. 347/101

(57) ABSTRACT

The image recording apparatus forms an image on each of at least two kinds of printing media of different widths by ejecting ink droplets thereon. The apparatus includes an ink ejection unit that ejects ink toward a front surface of a printing medium, a pair of ink receivers that receive the ink ejected outside both side edges of the printing medium in a width direction perpendicular to a transport direction of the printing medium and a first shield plate that is arranged outside a first edge of the printing medium in the width direction perpendicular to the transport direction of the printing medium, and moves in parallel to the front surface of the printing medium and in the width direction perpendicular to the transport direction of the printing medium in accordance with a position of an edge of each of the at least two kinds of printing media of the different widths.

### BACKGROUND OF THE INVENTION

This invention relates to an image recording apparatus for producing borderless prints by using an ink jet head, and more particularly to an image recording apparatus for performing borderless printing on recording media of different widths.

Ink jet printers that eject ink droplets from an ink jet head onto a recording medium such as a recording sheet and form an image thereon have been widespread. Images printed by the ink jet printers have an image quality almost equal to that of silver halide photographs because of the recent progress of the image processing technology, image recording technology, and ink jet head designing.

In the photographic prints produced by digital photo printers, a print with no blank spaces or the like around an image, i.e., a borderless print bearing an image recorded up to the borders (edges) thereof has been mainstream, and ink jet printers that can print images with no blank spaces around them are in practical use. In the case of borderless printing, ink needs to be ejected even beyond the edges of the recording medium to form an image on a recording medium, so that an ink receiver or the like is provided by the side of the recording medium to protect the inside of the printer from being contaminated due to the ink ejected outside the recording medium.

For example, there is disclosed an ink jet printer in JP 2003-104600 A. In order to protect a printing medium from being contaminated by the ink ejected outside the printing medium, the ink jet printer uses a transport belt which has a width narrower than that of the printing medium as the belt for transporting the printing medium under attraction by suction, and includes an ink receiver for receiving the ink ejected outside the printing medium.

### SUMMARY OF THE INVENTION

In the ink jet printer disclosed in JP 2003-104600 A, two kinds of ink receivers are formed in a printing stage on which a printing medium is placed. One of the ink receivers is used in the case of transporting a printing medium having a narrow width, and the other is for a printing medium having a width broader than the former one. However, when an image is recorded on the printing medium having a narrow width with this ink jet printer, ink may spatter outside the ink receiver to adhere to the printing stage, or even to the transport belt and the like. Therefore, there has been a problem in that when the printing medium having a broad width is transported on the printing stage to form an image thereon, the ink having spattered to adhere to the printing stage may cause stain of the back surface of the printing medium.

The present invention has been accomplished in order to solve the above problem, and an object of the present invention is to provide an image recording apparatus that prevents ink from contaminating the inside of the apparatus and adhering to a printing stage with suction holes in a case of performing borderless printing, thereby protecting a back surface of a recording medium from being contaminated by the ink even during borderless printing on recording media of different widths.

In order to solve the above problem, a first aspect of the present invention provides an image recording apparatus that forms an image on each of at least two kinds of printing media of different widths by ejecting ink droplets thereon, including:

ink ejection means that ejects ink toward a front surface of a printing medium;

a pair of ink receivers that receive the ink ejected outside both side edges of the printing medium in a width direction perpendicular to a transport direction of the printing medium; and

a first shield plate that is arranged outside a first edge of the printing medium in the width direction perpendicular to the transport direction of the printing medium, and moves in parallel to the front surface of the printing medium and in the width direction perpendicular to the transport direction of the printing medium in accordance with a position of an edge of each of the at least two kinds of printing media of the different widths.

Preferably, the image recording apparatus of the present invention further including: a printing stage that sucks a back surface of the printing medium that is opposite to the front surface and supports the printing medium, wherein the pair of ink receivers are formed in the printing stage at positions corresponding to both side edges of the at least two kinds of printing media of the different widths. Alternatively, preferably, each of the pair of ink receivers includes a movable ink receiver that moves in the width direction perpendicular to the transport direction of the printing medium in accordance with a width of each of the at least two kinds of printing media of different widths.

Further, in accordance with the image recording apparatus of the present invention, preferably, the at least two kinds of printing media of different widths are each transported with reference to a second edge opposite to the first edge of the printing medium.

Alternatively, preferably, the image recording apparatus of the present invention further including: a second shield plate that moves in parallel to the front surface of the printing medium and in the width direction perpendicular to the transport direction of the printing medium, wherein the at least two kinds of printing media of the different widths are each transported with reference to a center thereof in the width direction perpendicular to the transport direction.

Further, preferably, the ink ejection means reciprocates in parallel to the front surface of the printing medium and in the width direction perpendicular to the transport direction of the printing medium, and forms an image on the printing medium.

Further, preferably, the first shield plate includes an ink absorber that absorbs the ink on a surface of the ink absorber, the surface of the ink absorber being on a side on which the ink ejection means is arranged in a direction vertical to the front surface of the printing medium.

Further, preferably, the image recording apparatus of the present invention further including ejection position control means that allows the ink ejection means to eject the ink onto a specific position of the ink absorber of the first shield plate upon flushing operation, wherein the specific position is changed for every flushing operation.

According to the image recording apparatus of the present invention, the shield plate can suppress or prevent adhesion of ink to the transport path on which the recording sheet is transported even in the case of performing borderless printing on the recording sheets of multiple sizes, so that prints without any ink blots can be produced.

### BRIEF DESCRIPTION OF THE DRAWINGS

In the accompanying drawings:

FIG. 1 is a schematic configuration view of a digital photo printer according to the present invention;

FIG. 2 is a schematic plan view of a transport mechanism of the digital photo printer according to the present invention;

FIG. 3 is a schematic cross-sectional view of the transport mechanism in FIG. 2, taken along the line III-III;

FIG. 4 is a schematic cross-sectional view of the transport mechanism during borderless printing on a recording sheet having a broad width;

FIG. 5 is a schematic plan view of the transport mechanism in a case where a recording sheet is transported with one lateral edge as the reference;

FIG. 6 is a schematic plan view of a transport mechanism comprising movable ink receivers;

FIG. 7 is a schematic cross-sectional view of the transport mechanism in FIG. 6, taken along the line VII-VII;

FIG. 8 is a schematic cross-sectional view of the transport mechanism including the movable ink receivers during borderless printing on a recording sheet having a broad width; and

FIG. 9 is a schematic cross-sectional view of a transport mechanism comprising guide units for sucking a recording sheet.

### DESCRIPTION OF THE PREFERRED EMBODIMENTS

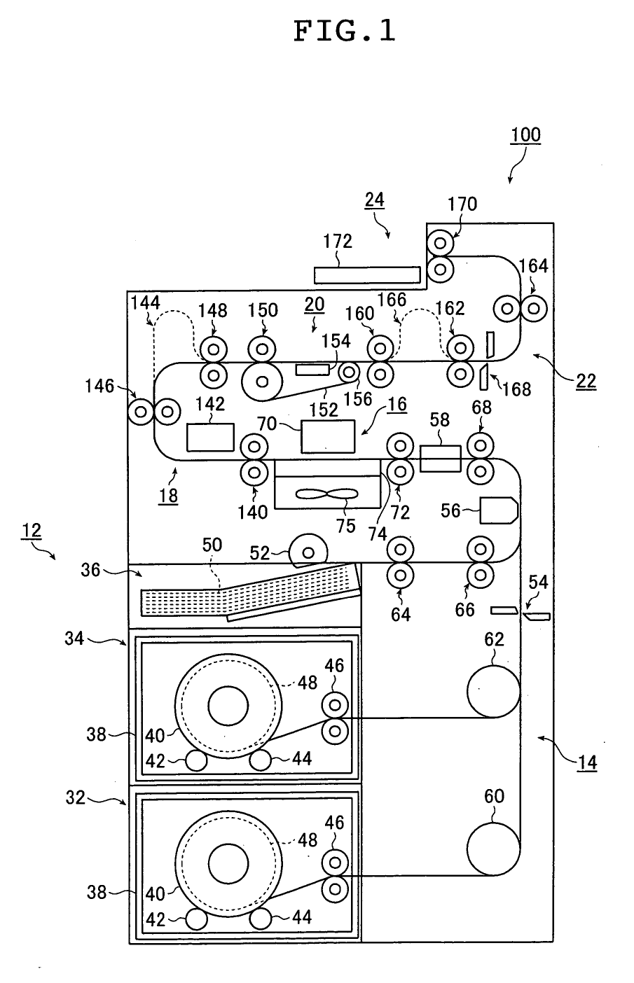

A digital photo printer according to the present invention will be described below referring to FIG. 1. FIG. 1 is a schematic configuration view of the digital photo printer.

A digital photo printer 100 comprises a recording sheet loading section 12, a recording sheet supplying section 14, an image recording section 16, a drying section 18, a surface treatment section 20, a cutting section 22, and a discharge section 24.

The recording sheet loading section 12 mainly comprises a first rolled recording sheet loading unit 32, a second rolled recording sheet loading unit 34, and a recording sheet cassette 36.

The first rolled recording sheet loading unit 32 is arranged at the lower part in the digital photo printer 100. The second rolled recording sheet loading unit 34 is arranged above the first rolled recording sheet loading unit 32, above which the recording sheet cassette 36 is arranged. The first rolled recording sheet loading unit 32 and the second rolled recording sheet loading unit 34 are different from each other in location but basically the same in configuration, so that the configuration of only the first rolled recording sheet loading unit 32 is explained below and the explanation of the second rolled recording sheet loading unit 34 will be omitted here. In FIG. 1, each component of the second rolled recording sheet loading unit 34 that is the same as that of the first rolled recording sheet loading unit 32 is given the same reference numeral.

As shown in FIG. 1, the first rolled recording sheet loading unit 32 is arranged at the lower part in the digital photo printer 100, and comprises a magazine 38, flanges 40, flange rotation rollers 42 and 44, and a feed roller pair 46. The flanges 40, the flange rotation rollers 42 and 44, and the feed roller pair 46 are provided in the magazine 38. In the digital photo printer 100 in the illustrated example, the magazine 38 is drawn out of the casing of the digital photo printer 100, and a rolled recording sheet 48 as a printing medium is loaded into the magazine 38. In the case of using a rolled recording sheet having a narrow width, a plurality of rolled recording sheets may be arranged in parallel in the direction perpendicular to the plane surface of the figure (i.e., rotation axis direction), which allows the recording sheets having a narrow width to be subjected to image recording while being transported in two or more lines in parallel. As a result, the printing efficiency can be improved.

The rolled recording sheet 48 is wound around a cylindrical core member (not shown) so that the image recording surface may be outward in the radial direction. There is no particular limitation to the length and the dimension in the width direction of the rolled recording sheet 48. For example, a long (namely, web-type) recording sheet whose width is in a range of 89 mm to 210 mm can be used. Moreover, a recording sheet having any arbitrary surface type can be used. For example, a recording sheet having a glossy surface or a matte surface, or a recording sheet onto the substrate of which thermoplastic resin is applied can be used.

The flange 40 is attached and fixed to both the sides of the core member of the rolled recording sheet 48, and the outer diameter of the flanges 40 is set to be larger than the maximum outer diameter of the rolled recording sheet 48. The flanges 40 have a function of regulating the edges of the rolled recording sheet 48 in the width direction and guiding the recording sheet so that its roll may not collapse in the width direction. The flanges 40 rotate together with the rolled recording sheet 48 as the flange rotation rollers 42 and 44 to be described below rotate.

The flange rotation rollers 42 and 44 are arranged below the flanges 40 to be parallel to each other with a predetermined interval therebetween in the horizontal direction. The flange rotation rollers 42 and 44 support the flanges 40 by abutting against the outer peripheries of the flanges 40. The flange rotation rollers 42 and 44 are each connected to a rotary driving unit (not shown). The flanges 40 are rotated by the forward or backward rotation of the flange rotation rollers 42 and 44, and the rolled recording sheet 48 can be fed (unwound) or wound up.

The feed roller pair 46 nips the recording sheet 48 as unwound and transports it to the later-described recording sheet supplying section 14.

The recording sheet cassette 36 is a member for containing a pile of recording sheets 50 prepared beforehand as cut sheets with a predetermined size, and is removably attached to the digital photo printer 100. The recording sheets 50 are piled in the recording sheet cassette 36 so that the image recording surfaces thereof are directed downward. The recording sheets 50 in the recording sheet cassette 36 are picked up one by one by a feed roller 52 located above the recording sheet cassette 36 to be fed to the later-described recording sheet supplying section 14.

In this embodiment, the first rolled recording sheet loading unit 32 and the second rolled recording sheet loading unit 34 may load the same type of rolled recording sheet or different types of rolled recording sheets such as recording sheets with different surface types or sizes (i.e., widths).

The recording sheet supplying section 14 is provided so as to transport a long recording sheet or cut recording sheet fed from the recording sheet loading section 12 to the image recording section 16. The recording sheet supplying section 14 comprises a cutter 54, a back printing unit 56, a width guide 58, two turn rollers 60 and 62, and three feed roller pairs 64, 66, and 68.

The turn rollers 60 and 62 change the transport direction of the long recording sheets fed nearly horizontally from the first rolled recording sheet loading unit 32 and the second rolled recording sheet loading unit 34, respectively, so that the recording sheets are transported toward the back printing unit 56 located above. The cutter 54 is provided on the transport path between the turn rollers 60 and 62 and the back printing unit 56. After a predetermined operation has been completed, or when the rolled recording sheet which has not been used up is exchanged with another recording sheet, the cutter 54 cuts the long recording sheet.

The feed roller pairs 64 and 66 can transport the recording sheets 50 fed from the recording sheet cassette 36 toward the back printing unit 56.

The back printing unit 56 is a printing device for recording predetermined back print information on the surface of a long rolled recording sheet or cut recording sheet which is the opposite side of the image recording surface, and is provided downstream of the feed roller pair 66 in the transport direction. For example, a dot impact matrix printer or an ink jet printer is used for the back printing unit 56. Examples of the back print information recorded by the back printing unit 56 include an image file name, and image correction information.

The feed roller pair 68 transports the long recording sheet or cut recording sheet which has been subjected to back printing by the back printing unit 56 toward the width guide 58.

The width guide 58 is provided upstream of a feed roller pair 72 of the image recording section 16 which will be described in detail, and can adjust the position of the long rolled recording sheet or the cut recording sheet entering the image recording section 16 in the width direction.

Next, the image recording section 16 will be explained in detail. The image recording section 16 comprises a recording head 70, the feed roller pair 72, and a transport mechanism 74. The feed roller pair 72 can transport the recording sheet whose position in the width direction has been regulated by the width guide 58 to the transport mechanism 74.

The recording head 70 is a serial type ink jet head that forms an image on the recording sheet while reciprocating in the width direction of the recording sheet (i.e., main scanning direction). The recording head 70 is arranged opposite to the transport mechanism 74 as shown in FIG. 1, and can form a color image on the recording sheet transported by the transport mechanism 74. In the image recording section 16 of the illustrated example, the recording head 70 ejects ink droplets onto the recording sheet while moving in the width direction of the recording sheet, and the recording sheet is intermittently moved forward by a length corresponding to the length (i.e., size in the transport direction) of the image formed by the recording head 70 every time the recording head 70 has reciprocated or moved in one direction. Such operation is repeated, and an image can be recorded on the recording sheet.

The recording head 70 comprises a plurality of nozzles for ejecting ink. Four nozzle rows corresponding to four colors, cyan (C), magenta (M), yellow (Y), and black (K), respectively, are formed on the ink ejection side of the recording head 70. The four nozzle rows are arranged in parallel in the main scanning direction. As the driving system for the recording head 70, any driving system including a piezoelectric system that utilizes vibration by piezoelectric elements, a thermal system that utilizes pressure of air bubbles generated in the ink by heating elements, and an electrostatic system that utilizes electric charges given to ink droplets can be employed.

As described above, the recording head 70 of this embodiment can form an image on the recording sheet by reciprocating in the main scanning direction. As the method for moving the recording head 70 in the main scanning direction, any method used in known ink jet printers can be employed, which includes a method using a belt and pulley, and a method using a screw transmission.

Upon forming an image on the recording sheet, the recording head 70 can perform borderless printing in which the image is recorded up to the borders (edges) of the recording sheet by ejecting the ink even beyond both side edges of the recording sheet.

The serial head is used as the recording head 70, however, the recording head 70 is not limited thereto. It is possible to use a line head in which a plurality of nozzles are arranged along the length approximately equal to the maximum width of the recording sheets to be used.

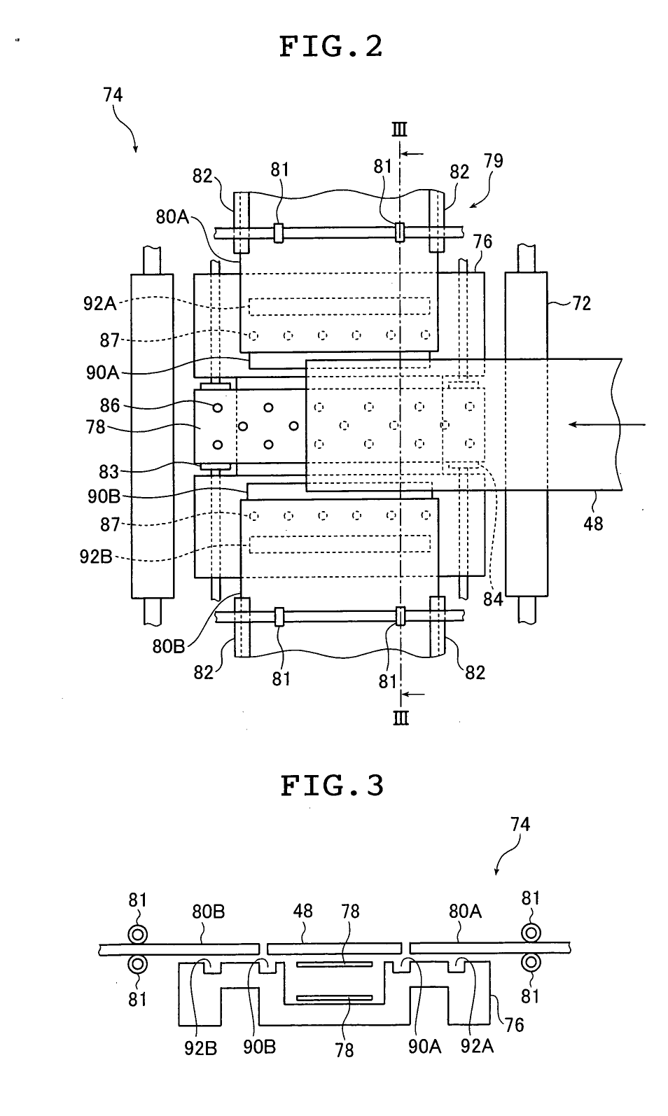

Next, the transport mechanism 74 will be explained in detail referring to FIGS. 2 and 3. FIG. 2 is a schematic plan view of the transport mechanism, and FIG. 3 is a schematic cross-sectional view of the transport mechanism in FIG. 2, taken along the line III-III. The transport mechanism 74 in the illustrated example can deal with transportation of two kinds of recording sheets of different widths.

As shown in FIG. 2, the transport mechanism 74 comprises a printing stage with suction holes 76 for placing the recording sheet 48, a transport belt 78 for transporting the recording sheet 48 intermittently by a predetermined amount, and a shield mechanism 79 for shielding a part of the printing stage 76. The transport mechanism 74 shown in FIG. 2 is constructed so that the recording sheet is transported with its center as the reference. That is, when recording sheets of different widths are used, the respective recording sheets are transported so that the centers thereof in the width direction accord with one another.

As shown in FIG. 1, a fan 75 is arranged under the printing stage 76 as a suction mechanism. The fan 75 can generate the air flow flowing downward from the printing stage 76 located above the fan 75. The number of the fans 75 used may be one or more.

The transport belt 78 can transport the recording sheet 48 fed from the feed roller pair 72 while attracting the recording sheet 48 thereto. Many suction holes 86 are uniformly formed in the transport belt 78. With the fan 75 being driven, the recording sheet is attracted to the transport belt 78 by suction through the suction holes 86. The transport belt 78 is an endless belt stretched around a driving roller 83 connected to a not-shown drive source and a driven roller 84. The driving roller 83 is rotatably driven in an intermittent manner, so that the transport belt 78 can be intermittently moved.

In the case of using a line head as the recording head 70, the transport belt 78 can continuously transport the recording sheet at a constant speed.

First ink receivers 90A and 90B, and second ink receivers 92A and 92B are formed in the printing stage 76. In the case where the recording head 70 performs borderless printing on the recording sheet with a narrow width, the first ink receivers 90A and 90B receive the ink ejected outside the recording sheet. On the other hand, in the case where the recording head 70 performs borderless printing on the recording sheet with a broad width, the second ink receivers 92A and 92B receive the ink ejected outside the recording sheet. Each of the ink receivers 90A, 90B, 92A, and 92B is an elongated groove extending in the transport direction of the recording sheet, and is formed outside the edge of the transport belt 78 in the width direction. The first ink receivers 90A and 90B are symmetric with respect to the centerline of the transported recording sheet in the width direction, which is the same in the second ink receivers 92A and 92B. The ink receivers 90A, 90B, 92A, and 92B are formed in the printing stage 76 so that each of them approximately accords with the edge of the recording sheet which is transported with the center as the reference.

Each of the ink receivers 90A, 90B, 92A, and 92B is slightly longer than the recording head 70 in the transport direction. Considering that an image larger than the size of the sheet is printed, and displacement of the transporting position of the sheet may occur, it is preferable that the width of each of the ink receivers 90A, 90B, 92A, and 92B be somewhat large. In this case, the center of each of the ink receivers in the width direction accords with the side edge of the sheet.

Suction holes 87 are formed between the ink receivers 90A and 92A and between the ink receivers 90B and 92B in the printing stage 76 to align at constant intervals in the transport direction. When the recording sheet with a broad width is transported, the recording sheet can be sucked through the suction holes 87 by the suction force generated by the fan 75, so that the recording sheet can be attracted to the printing stage 76.

The suction forces through the suction holes 86 in the transport belt 78 and through the suction holes 87 in the printing stage 76 may be the same or different. As a method for making the suction forces through the suction holes 86 in the transport belt 78 and the suction holes formed in the printing stage 76 different from each other, for example, the size of each suction hole may be changed, or the number of the suction holes may be changed.

In the case where the suction force through the suction holes 87 formed in the printing stage 76 is too strong, transportation of the recording sheet 48 may become difficult. Thus, it is desirable that the suction force through the suction holes 87 formed in the printing stage 76 be set so that the recording sheet 48 can be transported by the transport belt 78.

The shield mechanism 79 comprises two shield plates 80A and 80B, a plurality of roller pairs 81 provided to nip the shield plates 80A and 80B, guides 82 for guiding the shield plates 80A and 80B, and a motor (not shown) for rotating the roller pairs 81. The shield plates 80A and 80B are each a plate-like member having a rectangular contour, and are provided on both sides of the transport belt 78 in the width direction while being apart from the upper surface of the printing stage 76 by a predetermined interval. Also, the shield plates 80A and 80B are arranged so that the upper surfaces thereof are located lower than the surface of the recording head 70 on the ink ejection side, whereby the shield plates 80A and 80B are not in contact with the recording head 70 at the time of recording. Preferably, the shield plates 80A and 80B are arranged so that the upper surfaces thereof are located at the same height as the image forming surface of the recording sheet to be transported. The guides 82 are provided at both side edges of each of the shield plates 80A and 80B, and the shield plates 80A and 80B move forward or backward in the direction perpendicular to the transport direction while being guided by the guides 82.

As shown in FIGS. 2 and 3, the rollers of each roller pair 81 are provided on the upper and lower surfaces of each of the shield plates 80A and 80B, respectively, so that the shield plates 80A and 80B are each nipped by the roller pairs 81. Each roller of the roller pairs 81 arranged below the shield plates 80A and 80B is connected to a not-shown motor, so the shield plates 80A and 80B can be moved forward or backward by rotating the motor in the forward or backward direction while maintaining a horizontal state with respect to the surface of the printing stage 76.

The mechanism for horizontally moving the shield plates 80A and 80B is not limited to one that utilizes the roller pairs 81 and the guides 82 shown in FIGS. 2 and 3, and any known movement mechanism can be utilized so long as the movement mechanism can move the flat shield plates 80A and 80B horizontally with respect to the upper surface of the printing stage 76.

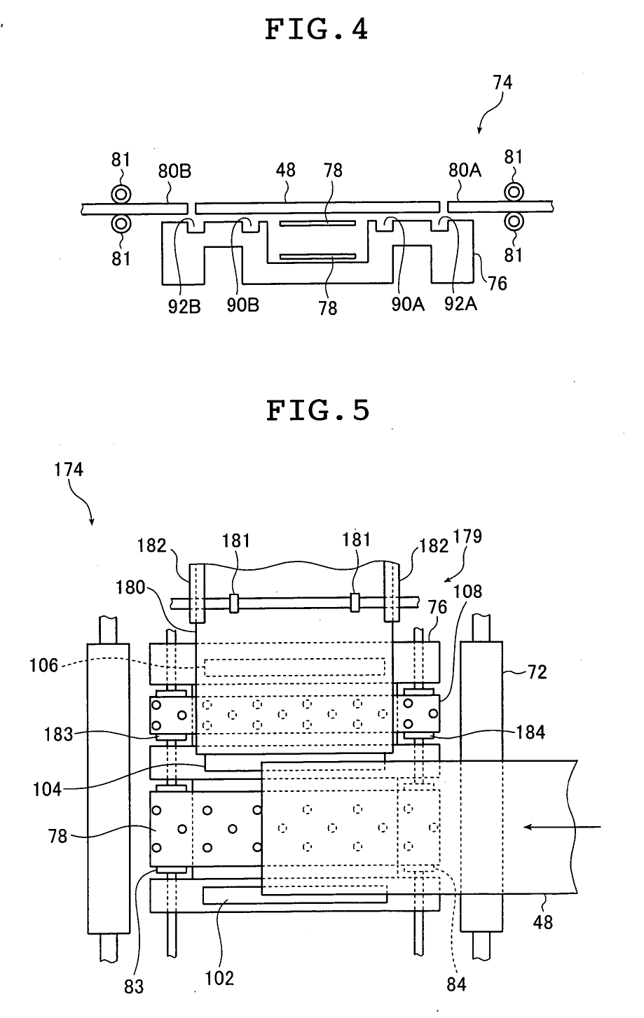

In the case of performing borderless printing on the recording sheet with a narrow width, as shown in FIG. 3, the shield plates 80A and 80B are moved in the shield mechanism 79 so that the inner edges of the shield plates 80A and 80B approximately accord with the outer edges of the first ink receivers 90A and 90B, respectively. Thus, a part of the transport surface of the printing stage 76 located outside the both side edges of the recording sheet with a narrow width is not exposed, but is shielded by the shield plates 80A and 80B. On the other hand, in the case of performing borderless printing on the recording sheet having a broad width, as shown in FIG. 4, the shield plates 80A and 80B are preferably moved in the shield mechanism 79 so that the inner edges of the shield plates 80A and 80B approximately accord with the outer edges of the second ink receivers 92A and 92B, respectively. That is, in the case of performing borderless printing on the recording sheet having a narrow width, the shield plates 80A and 80B are moved forward so that the inner edges thereof approach the first ink receivers 90A and 90B as shown in FIG. 3. In the case of performing borderless printing on the recording sheet having a broad width, the shield plates 80A and 80B are retracted in a direction receding from the centerline of the transported recording sheet in the width direction (i.e., direction perpendicular to the transport direction), and the inner edges of the shield plates 80A and 80B are preferably arranged near the second ink receivers 92A and 92B, respectively. Thus, when performing borderless printing on the recording sheet having a narrow width, even in the case where the ink droplets are spattered outside the first ink receivers 90A and 90B, since the upper surface of the printing stage 76 is shielded by the shield plates 80A and 80B, the ink does not adhere to the transport path of the printing stage 76 for the recording sheet. Therefore, even if the recording sheet having a narrow width is exchanged for that having a broad width, and the recording sheet having a broad width is transported on the printing stage 76 for forming an image thereon, it is prevented that the ink droplets spatter onto the upper surface of the printing stage 76 to adhere to the back surface of the recording sheet, thereby making it possible to produce prints with less ink blots.

The recording sheet does not move in the area further outside the second ink receivers 92A and 92B, so that in the case of performing borderless printing on the recording sheet having a broad width, the shield plates 80A and 80B are not necessarily arranged near the second ink receivers 92A and 92B, respectively. That is, in the case of performing borderless printing on the recording sheet having a broad width, the shield plates can be arranged at any position outside the second ink receivers 92A and 92B. However, in order to protect the inside of the apparatus as much as possible from being contaminated due to the ink droplets spattered, when performing borderless printing on the recording sheet having a broad width, as described above, the shield plates 80A and 80B are preferably arranged near the second ink receivers 92A and 92B, respectively.

In a preferable form of the illustrated example, the inner edges of the shield plates 80A and 80B approximately accord with the outer edges of the first ink receivers 90A and 90B, or the second ink receivers 92A and 92B, respectively. However, the shield plates 80A and 80B may be arranged in such a way that they each do not contact the edge of the recording sheet to be transported and shield part of the opening of the first ink receiver 90A or 90B or the second ink receiver 92A or 92B.

In the illustrated example, the shield plates 80A and 80B are arranged so that a predetermined gap is formed between the shield plates 80A and 80B and the upper surface of the printing stage 76, however, at the time of forming an image, the upper surface of the printing stage 76 and the shield plates 80A and 80B may be in contact with each other. Thus, it is prevented that the ink enters the gap formed between the shield plates 80A and 80B and the upper surface of the printing stage 76, which results in preventing the ink from adhering to the upper surface of the printing stage 76 more surely. In this case, a movement device for moving the shield plates 80A and 80B in the vertical direction (i.e., in a direction vertical to the transport surface of the recording sheet) may be further provided.

In the present invention, the shield plates 80A and 80B may be made of, for example, plastic or metal. Preferably, the upper surfaces of the shield plates 80A and 80B have ink absorption property to absorb the ink spattered thereon, which is realized by various methods including, for example, a method of forming the shield plates from an ink absorber, and a method of forming a layer made of an ink absorber on the upper surfaces of the shield plates. As the ink absorber, a material such as a nonwoven fabric can be utilized. In the case of forming the layer made of the ink absorber on the upper surfaces of the shield plates, a preferable material of the ink absorber is one that can absorb ink in a concentrated manner at the edge portions of the shield plates and can be easily exchanged.

A flushing zone may be provided at a specific position on the upper surfaces of the shield plates 80A and 80B for performing flushing operation for the recording head 70. In this case, the flushing operation of the recording head 70 can be performed without returning to its original position. For example, the flushing zone may be provided at any position excluding the edge portions of the ink absorber, and the ink flushing position in the flushing zone is changed for every flushing operation. In order to realize that, a not-shown main scanning control unit (i.e., ejection position control means) of the recording head may cause the memory or the other storage unit to store therein the position at which the ink was flushed for every flushing operation. Then, based on the current positions of the shield plates and the positional information on the previous flushing operations, the main scanning control unit of the recording head calculates the position for performing the next flushing operation, and controls the movement mechanism that moves the recording head to the calculated position. In the case where there is no position left for the flushing operation, the configuration may be such that a lamp or the like is turned on so as to urge a user to exchange the ink absorber.

The transport mechanism 74 shown in FIGS. 2 and 3 is an example of a transport mechanism that transports the recording sheets 48 of different widths with the center as the reference. However, the present invention is not limited thereto, and the transport mechanism 74 may be configured to transport the recording sheets 48 of different widths with one lateral edge as the reference. That is, the transport mechanism 74 may be configured to transport the recording sheet of any width while arranging the recording sheet with reference to one lateral edge of the recording sheet.

FIG. 5 schematically shows a configuration example of the transport mechanism for transporting the recording sheet with one lateral edge as the reference. A transport mechanism 174 shown in FIG. 5 comprises the printing stage 76, a common ink receiver 102, a first ink receiver 104, and a second ink receiver 106.

The first ink receiver 104 is formed at a position apart from the common ink receiver 102 by the width of the recording sheet having a narrow width in a direction perpendicular to the transport direction of the recording sheet. On the other hand, the second ink receiver 106 is formed at a position apart from the common ink receiver 102 by the width of the recording sheet having a broad width in a direction perpendicular to the transport direction of the recording sheet. Thus, in the case of transporting the recording sheet having a narrow width, the common ink receiver 102 and the first ink receiver 104 are positioned at the edges of the recording sheet, respectively, and in the case of transporting the recording sheet having a broad width, the common ink receiver 102 and the second ink receiver 106 are positioned at the edges of the recording sheet, respectively.

The transport belt 78 which is the same as that of the transport mechanism shown in FIG. 2 is provided between the common ink receiver 102 and the first ink receiver 104. In the transport mechanism 174 shown in FIG. 5, a transport belt 108 is also provided between the first ink receiver 104 and the second ink receiver 106. Hereinafter, the transport belt 78 provided between the common ink receiver 102 and the first ink receiver 104 is referred to as the first transport belt, and the transport belt 108 provided between the first ink receiver 104 and the second ink receiver 106 is referred to as the second transport belt. The second transport belt 108 is stretched around a driving roller 183 and a driven roller 184, and many suction holes are uniformly formed therein like the first transport belt 78. The driving roller 183 and the driving roller 83, and the driven roller 184 and the driven roller 84 are respectively arranged in a coaxial manner. The driving roller 83 and the driving roller 183 are rotated by a not-shown motor, whereby the first transport belt 78 and the second transport belt 108 are moved at the same speed.

In the transport mechanism 174 shown in FIG. 5, a shield mechanism 179 is provided on the side opposite to one side edge of the recording sheet which is used as the reference for transporting the recording sheet. The shield mechanism 179 comprises the shield plate 180, roller pairs 181, and guides 182. The guides 182 are provided at both side edges of the shield plate 180, and the rollers of each roller pair 181 are provided on the upper and lower surfaces of the shield plate 180, respectively, so as to nip the shield plate 180. The roller pairs 181 are rotated, so that the shield plate 180 can move along the guides 182 in a direction perpendicular to the transport direction.

With the transport mechanism 174 of such configuration, in the case of transporting the recording sheet having a narrow width, the shield plate 180 is moved in the direction perpendicular to the transport direction so that the edge of the shield plate 180 is positioned approximately over the outer edge of the first ink receiver 104. At this time, the recording sheet 48 is transported in a state of being attracted to the first transport belt 78. When performing borderless printing on the recording sheet 48, the recording head reciprocates between one edge to the other edge of the recording sheet. At this time, the ink ejected outside the edges of the recording sheet 48 is collected into the common ink receiver 102 and the first ink receiver 104. Since the upper surface of the printing stage 76 except the area where the recording sheet having a narrow width is transported is shielded with the shield plate 180, it is prevented that the ink spattered further outside the first ink receiver 104 adheres to the upper surface of the printing stage 76 or the surface of the second transport belt 108.

On the other hand, in the case of transporting the recording sheet having a broad width, the shield plate 180 is moved in the shield mechanism 79 so that the edge of the shield plate 180 is located at approximately the same position as the outer edge of the second ink receiver 106 or is located outside the outer edge of the second ink receiver 106 (i.e., on the side of the second ink receiver 106 that is further from the centerline of the transported recording sheet in the width direction). When the recording sheet having a broad width is used, the recording sheet is transported by the first and second transport belts 78 and 108 in a state of being attracted thereto. When performing borderless printing on the recording sheet, the recording head ejects the ink while reciprocating between one edge to the other edge of the recording sheet, thereby forming an image on the recording sheet. The ink ejected outside the edges of the recording sheet is collected into the common ink receiver 102 and the second ink receiver 106.

In the transport mechanism having such configuration, upon performing borderless printing on the recording sheet having a narrow width, since the transport surface of the printing stage 76 and the second transport belt 108 are shielded with the shield plate 180, the ink is prevented from adhering to the transport surface of the printing stage 76 and the second transport belt 108. Accordingly, when an image is formed on the recording sheet having a broad width, it is prevented that the ink adheres to the back surface of the recording sheet, thereby making it possible to produce prints with less ink blots.

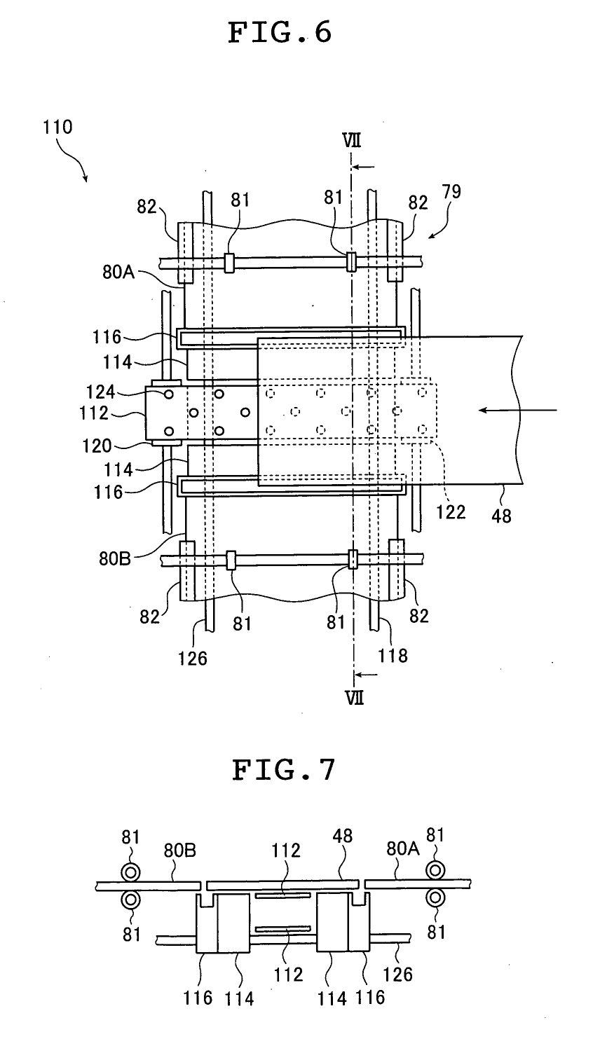

In the transport mechanism shown in FIGS. 2 to 5, the fixed type ink receivers are provided by forming the elongated grooves extending in the transport direction in the printing stage 76. However, the transport mechanism may be configured to include a movable type ink receiver. The transport mechanism comprising the movable type ink receivers will be explained below referring to FIGS. 6 and 7. FIG. 6 is a schematic plan view of the transport mechanism comprising the movable ink receivers, and FIG. 7 is a schematic cross-sectional view of the transport mechanism in FIG. 6, taken along the line VII-VII.

As shown in FIG. 6, a transport mechanism 110 comprises a transport belt 112 for transporting the recording sheet, guide units 114, 114 for supporting the back surface of the recording sheet to be transported, movable ink receivers 116, 116 for receiving the ink ejected outside the edges of the recording sheet, and the shield mechanism 79.

The transport belt 112 is stretched around a driving roller 120 and a driven roller 122. The driving roller 120 is connected to a not-shown motor, and the transport belt 112 is revolved by rotating the driving roller 120 by the motor. Many suction holes 124 are uniformly formed in the transport belt 112, and a not-shown suction unit is arranged below the transport belt 112. The suction unit is, for example, composed of a fan which generates the air flow flowing downward from the transport belt 112 side. With the fan being driven, the recording sheet is attracted by suction through the suction holes 124 formed in the transport belt 112. Consequently, the recording sheet in contact with the transport belt 112 is transported by revolving the transport belt 112.

The smoothly formed upper surfaces of the guide units 114, 114 support the back surface of the recording sheet 48 transported by the transport belt 112, so that the recording sheet 48 being transported can be kept flat. As shown in FIGS. 6 and 7, each guide unit 114 is provided to be in contact with the inner portion of one of the movable ink receivers 116, 116. That is, the guide unit 114 and the movable ink receiver 116 are configured as a unit.

Two through holes are formed at a predetermined interval in the transport direction in each movable ink receiver 116 of the transport mechanism 110 shown in FIGS. 6 and 7 so as to pass therethrough in a direction perpendicular to the transport direction. Two through holes are formed also in each guide unit 114 in the same way. Female threads are formed on the inner walls of the through holes that are positioned on the upstream side in the transport direction in the movable ink receivers 116, 116 and the guide units 114, 114. A ball screw 118 is screwed into the through holes, whereby the movable ink receivers 116, 116 and the guide units 114, 114 are connected to each other. A guide shaft 126 is engaged with the through holes in the movable ink receivers 116, 116 and the guide units 114, 114 that are positioned on the downstream side in the transport direction.

With the rotation of the ball screw 118, the movable ink receivers 116, 116 and the guide units 114, 114 can move in a direction perpendicular to the transport direction while being guided by the guide shaft 126. The male thread on the part of the ball screw 118 which is screwed into one movable ink receiver 116 winds in the direction opposite to that on the part of the ball screw 118 which is screwed into the other movable ink receiver 116, so that the movable ink receivers 116, 116 can be close to or apart from each other by rotating the ball screw 118.

The shield mechanism 79 shown in FIGS. 6 and 7 has the same configuration as the shield mechanism shown in FIGS. 2 and 3, so that each component thereof is given the same reference numeral and the explanation thereof is omitted. The shield plates 80A and 80B of the shield mechanism 79 in FIGS. 6 and 7 can move in synchronization with the movable ink receivers 116, 116.

The shield mechanism 79 in FIGS. 6 and 7 is configured such that the shield plates 80A and 80B move with the rotation of the roller pairs 81, however, the configuration may be such that each shield plate is fixed to the movable ink receiver so that the shield plate can move together with the movable ink receiver as a unit. Accordingly, the configuration of the apparatus can be simplified, and the cost of the apparatus can be reduced.

In the transport mechanism 110 having the configuration shown in FIGS. 6 and 7, since the movable ink receivers 116, 116 are provided, it is possible to promptly move the movable ink receivers 116, 116 to the positions corresponding to the edges of the recording sheet of any width, whereby borderless prints can be produced from the recording sheets of various widths.

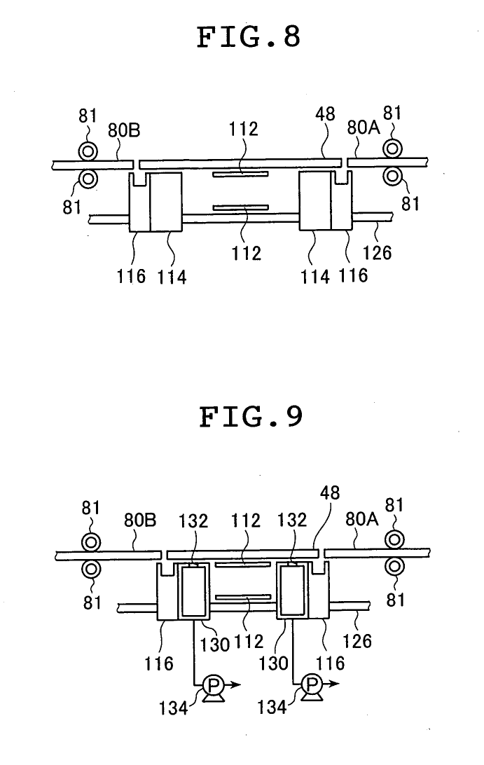

For example, in the case of performing borderless printing on the recording sheet having a narrow width, as shown in FIG. 7, the movable ink receivers 116, 116 are moved to the positions corresponding to the edges of the recording sheet having a narrow width, and further the shield plates 80A and 80B are moved to the outer edges of the movable ink receivers 116, 116. At this time, the shield plates 80A and 80B are located so that the edges thereof are disposed at the positions approximately corresponding to the outer edges of the movable ink receivers 116, 116, respectively. In the case of performing borderless printing on the recording sheet having a broad width, as shown in FIG. 8, the guide units 114, 114 and the movable ink receivers 116, 116 are moved so that the movable ink receivers 116, 116 correspond to the edges of the recording sheet, respectively, and the shield plates 80A and 80B are moved outward in synchronization with the movement of the movable ink receivers 116, 116. Similarly to the shield plates 80A and 80B shown in FIG. 7, the shield plates 80A and 80B are moved so that the edges thereof are disposed at the positions approximately corresponding to the outer edges of the movable ink receivers 116, 116, respectively.

According to the image recording section comprising the transport mechanism 110 of such configuration, in the case of performing borderless printing, the ink ejected outside the recording sheet is received by the movable ink receivers 116, 116, and the ink spattered outside the movable ink receivers 116, 116 adheres to the shield plates 80A and 80B, so that the inside of the apparatus is protected from being contaminated due to the spattered ink.

In the case of using the movable ink receivers, a sensor or the like may be provided for detecting the edges of the recording sheet. In this case, the ink receivers can be controlled to move to the positions corresponding to the edges of the recording sheet based on the detection results obtained by the sensor. Consequently, even when a recording sheet with a width other than the defined size is used, the ink receivers can be properly arranged at the edges of the recording sheet.

The transport mechanism 110 shown in FIGS. 6 and 7 is configured such that the movable ink receivers 116, 116 move symmetrically close to or apart from the centerline of the transported recording sheet in the width direction, however, the present invention is not limited thereto. The transport mechanism may be configured to include the movement mechanism which can move the respective movable ink receivers 116 independently in a direction perpendicular to the transport direction. Examples of such movement mechanism for moving the respective ink receivers independently include one configured as follows. That is, three through holes each passing through the ink receivers and the ink guides are formed, and a first ball screw for moving one of the two ink receivers (hereinafter, referred to as the first movable ink receiver), a second ball screw for moving the other ink receiver (hereinafter, referred to as the second movable ink receiver) and a guide shaft for guiding both ink receivers are engaged with the respective through holes. In this case, a thread is formed on a part of the first ball screw to which the first movable ink receiver is connected, and no thread is formed on a part of the first ball screw to which the second movable ink receiver is connected. No thread is formed on a part of the second ball screw to which the first movable ink receiver is connected, and a thread is formed on a part of the second ball screw to which the second movable ink receiver is connected. A female thread is formed on the inner wall of the through hole in the first movable ink receiver to which the first ball screw is connected, and no female thread is formed on the inner walls of the respective through holes in the first movable ink receiver to which the second ball screw and the guide shaft are connected. A female thread is formed on the inner wall of the through hole in the second movable ink receiver to which the second ball screw are connected, and no female screw thread is formed on the inner walls of the respective through holes in the second movable ink receiver to which the first ball screw and the guide shaft are connected. Thus, the first and second movable ink receivers can be moved independently in a direction perpendicular to the transport direction by rotating the first and second ball screws independently.

The transport mechanism of such configuration can position the ink receivers at the edges of the recording sheet even when the recording sheet is displaced in the width direction from the transporting position.

In the case where the first and second movable ink receivers can be moved independently, preferably, the transport belt 112 is also configured to be movable in the direction perpendicular to the transport direction. In this case, when recording sheets of different widths are used, it is preferable that the transport belt 112 be moved so that the center of the transport belt 112 always accords with the center of the recording sheet of any width in the width direction. Accordingly, even when the recording sheets of different widths are used, any recording sheet can be stably transported.

The movable ink receivers and the transport belt described above are useful when a line head is used as the recording head. For example, in the case where the line head is used as the recording head and an image is recorded while transporting the recording sheet with the center as the reference, some of the ink ejection units of the line head corresponding to the width of the recording sheet having a narrow width are always driven regardless of the width of the recording sheet to be used. Therefore, the ink is ejected more frequently from the ink ejection units that are positioned in the center of the line head and are always driven regardless of the width of the recording sheet to be used than from those at the end portions of the line head that are driven only when the recording sheet having a broad width is used. Thus, the ink ejection units positioned in the center of the line head tend to deteriorate more often. Accordingly, the position in the width direction of the recording sheet to be transported to the image recording section is positively changed so as to appropriately change the ink ejection region of the line head, whereby the ink ejection frequencies of the respective ejection units can be made even. Even when the position where the recording sheet fed into the image recording section is transported is changed in the width direction, the movable transport belt is moved according to this positional change, so that the recording sheet can be transported while being opposed to the line head. Even when the position where the recording sheet is transported is changed, the movable ink receivers can be moved to precisely correspond to the edges of the recording sheet. Thus, the movable ink receivers and the movable transport belt are useful in the case where the position where the recording sheet is transported is changed in the width direction for making the ink ejection frequencies of the respective ejection units of the line head even.

In the transport mechanism 110 shown in FIGS. 6 and 7, the movable guide units 114, 114 are preferably configured to suck the recording sheet to be transported. FIG. 9 shows an example of configuration of the transport mechanism comprising the guide units for sucking a recording sheet. The inside of each of guide units 130, 130 of the transport mechanism shown in FIG. 9 is hollow, and a plurality of through holes 132 communicating with the inside of each guide unit 130 are formed at constant intervals in the transport direction in the surface of each guide unit 130 which is in contact with the recording sheet. Pumps 134, 134 also each communicates with the inside of the guide unit 130, so that it is possible to exhaust the air from the guides 130, 130 by the pumps 134, 134, whereby the recording sheet 48 is sucked through the through holes 132.

Since the recording sheet 48 to be transported can be sucked through the through holes 132 of the guide units 130, 130 as described above, it is prevented that the edge of the sheet 48 droops or warps, whereby the recording sheet 48 can be kept flat.

In the above example, although the configuration is such that the transport belt transports the recording sheet, the long rolled recording sheet can be transported by the transport rollers shown in FIG. 1 without using the transport belt. Therefore, in the case of using only the long rolled recording sheet, the configuration may be such that the transport belt is not arranged, but the transport rollers on the downstream side are rotated so as to slightly pull the recording sheet, i.e., in such a manner that the transport speed of the transport rollers on the downstream side are set to be slightly higher than that of the transport rollers on the upstream side to exert tension on the recording sheet, and the recording sheet is placed on the printing stage capable of keeping only a recording part of the recording sheet flat or on the printing stage with suction holes having suction function. In this case, it is sufficient that a part of the printing stage in FIG. 2 where the transport belt is arranged is formed flat. Further, in this case, preferably, suction holes are formed in a part of the printing stage where the recording sheet is placed, and the recording sheet is sucked through the suction holes by using a pump, a fan or the like. Accordingly, the recording sheet being transported can be protected from floating or warping, and can be kept flat, so the distance between the recording head and the recording sheet can be kept constant, thus making it possible to form a high definition image without any deformation.

The transport mechanism has been explained above referring to the drawings.

Next, the drying section 18 will be explained referring to FIG. 1. The drying section 18 is provided in order to facilitate the drying of the ink on the recording sheet which has an image recorded thereon by the image recording section 16. The state of the drying of the ink is different depending upon the type of the recording sheet or the ink to be used. Thus, for example, in the case of using the recording sheet having such a property that the ink placed thereon dries immediately or using the ink which dries immediately, the drying section 18 need not be provided. In FIG. 1, the drying section 18 comprises a feed roller pair 140, and a drying fan 142. The drying fan 142 blows air to the image forming surface of the recording sheet being transported, thereby facilitating the drying of the ink. The feed roller pair 140 is provided to transport the recording sheet which has passed through the place in which the drying fan 142 is provided.

In the illustrated example, drying of the ink is facilitated by the drying fan, however, a heater may be used instead of the drying fan so as to facilitate the drying of the ink. In order to further facilitate the drying of the ink, the drying fan and the heater may be used in combination.

A loop forming unit 144 is provided downstream of the drying section 18 in the transport direction. When a long recording sheet is used, a loop is formed at the loop forming unit 144. The loop forming unit 144 comprises two feed roller pairs 146 and 148, and smoothes out the output speed differences generated among the image recording section 16, the drying section 18, and the later-described surface treatment section 20. By releasing a not-shown transport guide, a loop of the recording sheet is formed, and the load that affects the surface treatment section requiring continuous transport of the recording sheet can be avoided.

In the case of using a recording sheet in which thermoplastic resin is used for the image forming surface, the surface treatment section 20 can perform the surface treatment on the image forming surface. The surface treatment section 20 comprises a heat/pressure roller pair 150, a transport belt 152, a cooling unit 154, and a separation roller 156. The transport belt 152 is an endless belt which is stretched around the lower roller of the heat/pressure roller pair 150 and the separation roller 156.

The heat/pressure roller pair 150 can melt the thermoplastic resin of the image recording surface by heating and pressing the recording sheet. The transport belt 152 is for transferring its surface characteristics onto the thermoplastic resin of the image recording surface of the recording sheet that has been melted by the heat/pressure roller pair 150. Therefore, by making the surface of the transport belt 152 glossy, the image recording surface of the recording sheet can be made glossy.

The cooling unit 154 can solidify the melted thermoplastic resin by cooling it and thereby fix the surface characteristics transferred from the transport belt 152 to the recording sheet. The cooling unit 154 is arranged below the transport belt between the heat/pressure roller pair 150 and the separation roller 156 in the transport direction of the recording sheet.

The separation roller 156 is a roller over which the transport belt 152 is stretched. The diameter of the separation roller 156 is made extremely small, whereby the recording sheet whose thermoplastic resin was cooled and solidified can be separated from the transport belt 152.

The cutting section 22 is provided for cutting the rolled recording sheet into prints having a predetermined length, and comprises feed roller pairs 160, 162, and 164, a loop forming unit 166, and a cutter 168.

The feed roller pair 160 is provided downstream of the surface treatment section 20, and transports the recording sheet having passed through the surface treatment section 20. The linear speed of the feed roller pair 160 is controlled to accord with the transport speed of the recording sheet at the surface treatment section 20. The feed roller pair 162 is arranged downstream of the feed roller pair 160 in the transport direction by a predetermined interval, and transports the recording sheet to the cutter 168. During cutting of the recording sheet with the cutter 168, the transportation of the recording sheet needs to be temporarily stopped, so that the feed roller pair 162 is controlled to transport the recording sheet intermittently.

The loop forming unit 166 is provided between the feed roller pairs 160 and 162, and can smooth out the output speed difference between the surface treatment section 20 and the cutting section 22. By releasing a transport guide (not shown) arranged in a direction perpendicular to the transport surface, a loop of the recording sheet is formed at the loop forming unit 166. In consequence, the load that affects the surface treatment section 20 requiring continuous transport of the recording sheet is avoided, which results in stable surface treatment at the surface treatment section 20.

The discharge section 24 comprises a feed roller pair 170 and an orthogonal transport belt 172. The feed roller pair 170 is provided downstream of the feed roller pair 164 of the cutting section 22, and discharges the prints transported from the feed roller pair 164 through a discharging port (not shown) of the case of the digital photo printer. The orthogonal transport belt 172 can transport the prints discharged from the discharging port in the direction perpendicular to the plane surface of FIG. 1 (i.e., toward the viewer).

The prints transported by the orthogonal transport belt 172 are collected on a collection tray (not shown). The collection tray may be a circulation type sorter which sorts the prints in units of orders.

While the image recording apparatus of the present invention has been explained in detail, the present invention is in no way limited to the above described embodiments and it should be understood that various improvements and modifications are possible without departing from the gist of the present invention.

What is claimed is:

1. An image recording apparatus that forms an image on each of at least two kinds of printing media of different widths by ejecting ink droplets thereon, comprising:
ink ejection means that ejects ink toward a front surface of a printing medium;
a pair of ink receivers that receive the ink ejected outside both side edges of the printing medium in a width direction perpendicular to a transport direction of the printing medium; and
a first shield plate that is arranged outside a first edge of the printing medium in the width direction perpendicular to the transport direction of the printing medium, and moves in parallel to the front surface of the printing medium and in the width direction perpendicular to the transport direction of the printing medium in accordance with a position of an edge of each of the at least two kinds of printing media of the different widths.

2. The image recording apparatus according to claim 1, wherein each of the pair of ink receivers includes a movable ink receiver that moves in the width direction perpendicular to the transport direction of the printing medium in accordance with a width of each of the at least two kinds of printing media of different widths.

3. The image recording apparatus according to claim 1, further comprising: a printing stage that sucks a back surface of the printing medium that is opposite to the front surface and supports the printing medium, wherein the pair of ink receivers are formed in the printing stage at positions corresponding to both side edges of the at least two kinds of printing media of the different widths.

4. The image recording apparatus according to claim 1, wherein the at least two kinds of printing media of different widths are each transported with reference to a second edge opposite to the first edge of the printing medium.

5. The image recording apparatus according to claim 1, further comprising: a second shield plate that moves in parallel to the front surface of the printing medium and in the width direction perpendicular to the transport direction of the printing medium, wherein the at least two kinds of printing media of the different widths are each transported with reference to a center thereof in the width direction perpendicular to the transport direction.

6. The image recording apparatus according to claim 1, wherein the ink ejection means reciprocates in parallel to the front surface of the printing medium and in the width direction perpendicular to the transport direction of the printing medium, and forms an image on the printing medium.

7. The image recording apparatus according to claim 1, wherein the first shield plate includes an ink absorber that absorbs the ink on a surface of the ink absorber, the surface of the ink absorber being on a side on which the ink ejection means is arranged in a direction vertical to the front surface of the printing medium.

8. The image recording apparatus according to claim 7, further comprising ejection position control means that allows the ink ejection means to eject the ink onto a specific position of the ink absorber of the first shield plate upon flushing operation, wherein the specific position is changed for every flushing operation.
